(19) United States
(12) Patent Application Publication
(10) Pub. No.: US 2017/0211715 A1
(43) Pub. Date: Jul. 27, 2017

(54) OIL BYPASS VALVE WITH TEMPORARY SPACER TO PROVIDE INITIALLY OPENED FLUID CIRCUIT

(71) Applicant: GM GLOBAL TECHNOLOGY OPERATIONS LLC, Detroit, MI (US)

(72) Inventors: Adrian O. Balmaceda, Fair Haven, MI (US); Raymond H. Sasinowski, Brighton, MI (US); Ronald R. Semel, West Bloomfield, MI (US)

(73) Assignee: GM GLOBAL TECHNOLOGY OPERATIONS LLC, Detroit, MI (US)

(21) Appl. No.: 15/002,827

(22) Filed: Jan. 21, 2016

(51) Int. Cl. F16K 31/00; F28D 15/00; F16H 57/04; F28F 27/02

(52) U.S. Cl. CPC F16K 31/002; F28F 27/02; F28D 15/00; F16H 57/0412; F28D 2021/0089

(57) ABSTRACT

A fluid bypass valve includes a valve member disposed within a valve chamber. The valve member closes fluid communication between a first port and a second port disposed in a first position, and connects the first port and the second port in fluid communication when disposed in a second position. The valve member includes a temperature based actuating mechanism that positions the valve member in the first position when a temperature of a fluid is equal to or less than a pre-defined temperature, and positions the valve member in the second position when the temperature of the fluid is greater than the pre-defined temperature. A temporary spacer is disposed within the valve chamber, and positions the valve member in the second position. The temporary spacer includes a melting temperature approximately equal to the pre-defined temperature at which the valve member moves between the first position and the second position.

### TECHNICAL FIELD

The disclosure generally relates to a temperature based fluid bypass valve, and more specifically to a fluid bypass valve for a transmission fluid cooling circuit of a vehicle, and a method of assembling the transmission fluid cooling circuit.

### BACKGROUND

Some fluid circuits will include a temperature based fluid bypass valve to open or close fluid communication in a fluid circuit based on a temperature of the fluid. For example, a transmission fluid cooling circuit of a vehicle may include a fluid bypass valve that opens and closes fluid communication between a transmission and a fluid cooler, based on a temperature of the transmission fluid circulating through the fluid bypass valve. When the temperature of the transmission fluid is less than a pre-defined temperature, the fluid bypass valve closes fluid communication between the transmission and the fluid cooler, thereby allowing the transmission fluid to warm up quickly. When the temperature of the transmission fluid increases to a temperature greater than the pre-defined temperature, the fluid bypass valve opens fluid communication between the transmission and the fluid cooler to cool the transmission fluid. In transmission fluid cooling circuits, the pre-defined temperature at which the fluid bypass valve opens is typically around 85° C.

Accordingly, when the temperature of the transmission fluid is less than the pre-defined temperature, such as during assembly of the vehicle and/or initial filling of the fluid circuit, the fluid bypass valve is normally closed, i.e., is positioned to close fluid communication between the transmission and the fluid cooler. This prevents the transmission fluid from circulating through the fluid bypass valve, and the portions of the fluid circuit downstream of the fluid bypass valve. This prevents leak testing all of the connections in the fluid circuit downstream of the fluid bypass valve until the temperature of the transmission fluid is increased to the pre-defined temperature, and the fluid bypass valve opens.

### SUMMARY

A fluid bypass valve assembly is provided. The fluid bypass valve assembly includes a housing that defines a first port, a second port, and a valve chamber. A valve member is disposed within the valve chamber. The valve member is moveable between a first position and a second position. The valve member closes fluid communication between the first port and the second port when the valve member is disposed in the first position. The valve member connects the first port and the second port in fluid communication when the valve member is disposed in the second position. The valve member includes a temperature based actuating mechanism that is operable to position the valve member in the first position when a temperature of a fluid circulating through the housing is equal to or less than a pre-defined temperature. The temperature based actuating mechanism is operable to position the valve member in the second position when the temperature of the fluid is greater than the pre-defined temperature. A temporary spacer is disposed within the valve chamber, and positions the valve member in the second position. The temporary spacer has a melting temperature that is approximately equal to the pre-defined temperature at which the temperature based actuating mechanism moves the valve member between the first position and the second position.

A transmission fluid circuit is also provided. The transmission fluid circuit includes a transmission, a fluid cooler, and a bypass valve assembly. The bypass valve assembly includes a housing that defines a first port, a second port, a third port, a fourth port, a first passage connecting the third port and the fourth port in fluid communication, and a valve chamber. A transmission outlet line is attached to and disposed in fluid communication with the transmission and the first port for circulating fluid from the transmission to the bypass valve assembly. A cooler supply line is attached to and disposed in fluid communication with the second port and the fluid cooler for circulating fluid from the bypass valve assembly to the fluid cooler. A cooler outlet line is attached to and disposed in fluid communication with the fluid cooler and the third port for circulating fluid from the fluid cooler to the bypass valve assembly. A transmission supply line is attached to and disposed in fluid communication with the fourth port and the transmission for circulating fluid from the bypass valve assembly to the transmission. A valve member is disposed within the valve chamber, and is moveable between a first position and a second position. When disposed in the first position, the valve member closes fluid communication between the first port and the second port. When disposed in the second position, the valve member connects the first port and the second port in fluid communication. The valve member includes a temperature based actuating mechanism that is operable to position the valve member in the first position when a temperature of the temperature based actuating mechanism is equal to or less than a pre-defined temperature. The temperature based actuating mechanism is operable to position the valve member in the second position when the temperature of the temperature based actuating mechanism is greater than the pre-defined temperature. A temporary spacer is disposed within the valve chamber, between the first port and the second port. The temporary spacer positions the valve member in the second position when the temperature of the temperature based actuating mechanism is equal to or less than the pre-defined temperature. The temporary spacer has a melting temperature that is equal to or greater than the pre-defined temperature.

A method of assembling a transmission fluid circuit of a vehicle is also provided. The method includes providing a bypass valve assembly. The bypass valve assembly includes a housing defining a first port, a second port, and a valve chamber. A valve member is disposed within the valve chamber. The valve member is moveable between a first position closing fluid communication between the first port and the second port, and a second position connecting the first port and the second port in fluid communication. The valve member includes a temperature based actuating mechanism that is operable to position the valve member in the first position when a temperature of the temperature based actuating mechanism is equal to or less than a pre-defined temperature. The temperature based actuating mechanism is operable to position the valve member in the second position when the temperature of the temperature based actuating mechanism is greater than the pre-defined temperature. A temporary spacer is disposed within the valve chamber, between the first port and the second port. The temporary spacer positions the valve member in the second position when the temperature of the temperature based actuating mechanism is equal to or less than the pre-defined temperature. The temporary spacer has a melting temperature approximately equal to the pre-defined temperature. Fluid communication between the bypass valve assembly and a transmission is established. Additionally, fluid communication between the bypass valve assembly and a fluid cooler is established. The transmission, the bypass valve assembly, and the fluid cooler cooperate to define a fluid circuit through which a fluid circulates in a loop. The fluid is circulated through the fluid circuit with the fluid at a temperature of less than the pre-defined temperature. The fluid circuit is then inspected for leaks. The fluid is then circulated through the fluid circuit with the fluid at a temperature equal to or greater than the pre-defined temperature, to melt the temporary spacer and dissolve the temporary spacer into the fluid.

Accordingly, during initial assembly of the fluid circuit, prior to fluid circulating through the fluid bypass valve at temperatures greater than the pre-defined temperature at which the valve member moves between the first position and the second position, the temporary spacer positions the valve member in the second position to open fluid communication between the first port and the second port, thereby allowing the fluid to circulate through the entire fluid circuit, even though the fluid is at a temperature less than the pre-defined temperature when the fluid bypass valve normally closes fluid communication between the first port and the second port. This enables the inspection of the entire fluid circuit during initial assembly and filling of the fluid circuit. Once the fluid is heated to a temperature equal to or greater than the melting temperature of the temporary spacer, the temporary spacer melts and is dissolved into the fluid, thereby allowing the fluid bypass valve to operate normally.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic plan view of a fluid cooling circuit for a transmission of a vehicle.

FIG. 2 is a schematic cross sectional view of a fluid bypass valve of the fluid cooling circuit, showing a temporary spacer positioning a valve member into a second position.

FIG. 3 is a schematic cross sectional view of the fluid bypass valve after the temporary spacer has been dissolved, with the valve member in the second position.

FIG. 4 is a schematic cross sectional view of the fluid bypass valve showing the valve member in a first position.

FIG. 5 is a schematic perspective view of the temporary spacer.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

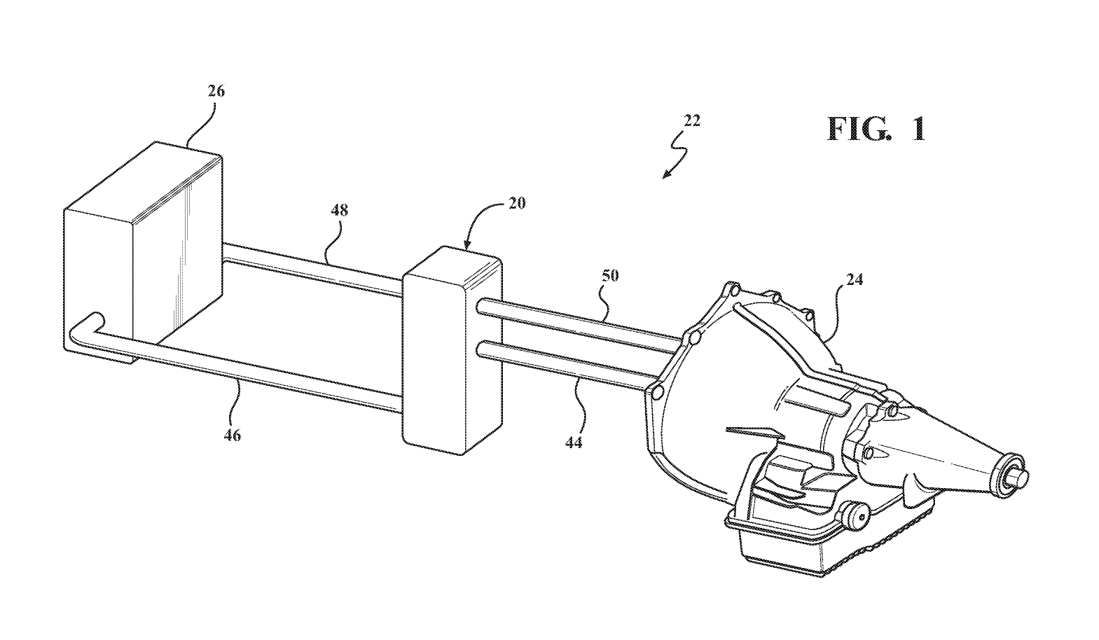

Referring to the Figures, wherein like numerals indicate like parts throughout the several views, a bypass valve assembly is generally shown at 20. The bypass valve assembly is shown and described herein as part of a transmission fluid cooling circuit, which is generally shown in FIG. 1 at 22. However, it should be appreciated that the bypass valve assembly 20 may be utilized in other fluid circuits, and should not be limited to the exemplary embodiment of the transmission fluid cooling circuit 22 described and shown herein.

Referring to FIG. 1, the transmission fluid cooling circuit 22 includes a transmission 24, a fluid cooler 26, and the bypass valve assembly 20. The transmission 24 may include any style and/or configuration of vehicular transmission 24 that circulates a fluid, hereinafter referred to as a transmission fluid, throughout for cooling and/or actuation and control of the transmission 24. While the exemplary embodiment of the detailed description describes the transmission fluid cooling circuit 22 circulating transmission fluid, it should be appreciated that the fluid may include some other type of fluid when the bypass valve assembly 20 is used in a system other than the exemplary transmission fluid cooling circuit 22. The specific operation and configuration of the transmission 24 is not pertinent to the detailed description, and is therefore not described in detail herein. The fluid cooler 26 may include any heat exchanger capable of transferring heat from the transmission fluid to another medium, such as a flow of air that flows across and/or through the fluid cooler 26. The specific configuration and/or operation of the fluid cooler 26 is not pertinent to the detailed description, and is therefore not described in detail herein.

The bypass valve assembly 20 controls fluid communication between the transmission 24 and the fluid cooler 26. The bypass valve assembly 20 may be configured in any suitable manner that is capable of closing fluid communication between the transmission 24 and the fluid cooler 26 when a temperature of the transmission fluid is less than a pre-defined temperature, and opening fluid communication between the transmission 24 and the fluid cooler 26 when the temperature of the transmission fluid is equal to or greater than the pre-defined temperature. The pre-defined temperature may be set to any temperature, and is dependent upon the specific system and type of fluid. For example, the pre-defined temperature for the transmission fluid cooling circuit 22 may be defined approximately equal to 85° C.

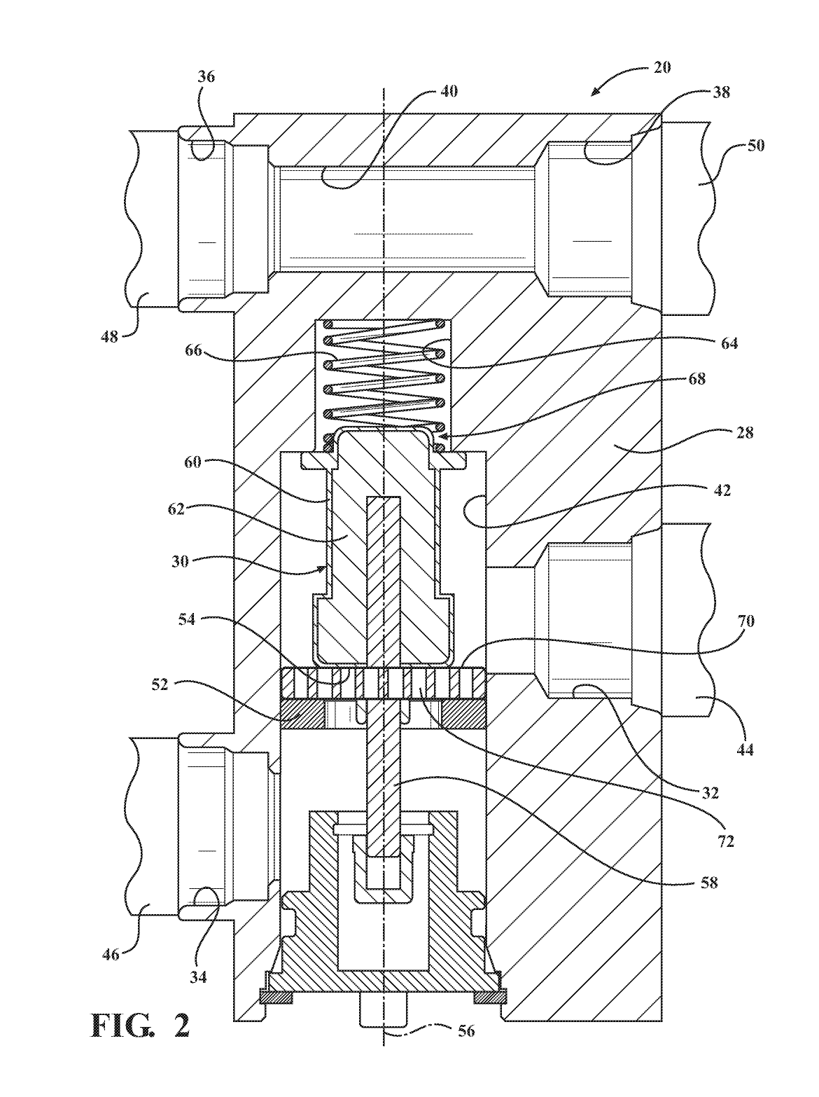

An exemplary embodiment of the bypass valve assembly 20 is shown and described herein. However, it should be appreciated that the bypass valve assembly 20 may be configured and operate differently than the exemplary embodiment. Referring to FIGS. 2 through 4, the bypass valve assembly 20 shown and described herein includes a housing 28, which supports a valve member 30. The housing 28 defines a first port 32, a second port 34, a third port 36, a fourth port 38, a first passage 40 connecting the third port 36 and the fourth port 38 in fluid communication, and a valve chamber 42.

The bypass valve assembly 20 is connected to the transmission 24 and the fluid cooler 26 in fluid communication. As shown in FIG. 1, a transmission outlet line 44 is attached to and disposed in fluid communication with the transmission 24 and the first port 32 of the bypass valve assembly 20 for circulating the transmission fluid from the transmission 24 to the bypass valve assembly 20. A cooler supply line 46 is attached to and disposed in fluid communication with the second port 34 of the bypass valve assembly 20 and the fluid cooler 26 for circulating the transmission fluid from the bypass valve assembly 20 to the fluid cooler 26. A cooler outlet line 48 is attached to and disposed in fluid communication with the fluid cooler 26 and the third port 36 of the bypass valve assembly 20 for circulating the transmission fluid from the fluid cooler 26 to the bypass valve assembly 20. A transmission supply line 50 is attached to and disposed in fluid communication with the fourth port 38 of the bypass valve assembly 20 and the transmission 24 for circulating the transmission fluid from the bypass valve assembly 20 to the transmission 24. While the transmission 24, the bypass valve assembly 20, and the fluid cooler 26 are shown in the figures and described as being connected by the various connecting lines (i.e., the transmission outlet line 44, the cooler supply line 46, the cooler outlet line 48, and the transmission supply line 50), it should be appreciated that one or more of the various connecting lines may be defined by an internal passage in either the fluid cooler 26 and/or the transmission 24. For example, the bypass valve assembly 20 may be mounted to the transmission 24, with the transmission 24 defining the internal passages corresponding to the transmission outlet line 44 and/or the transmission supply line 50.

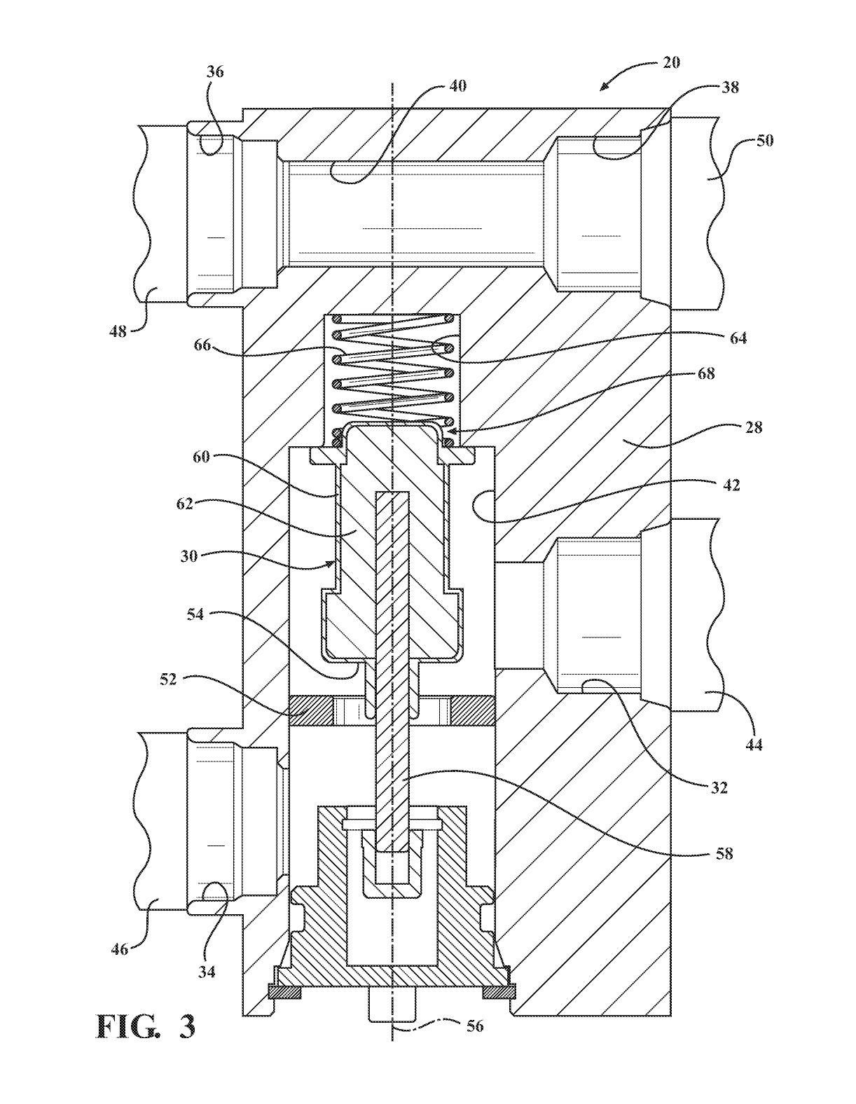

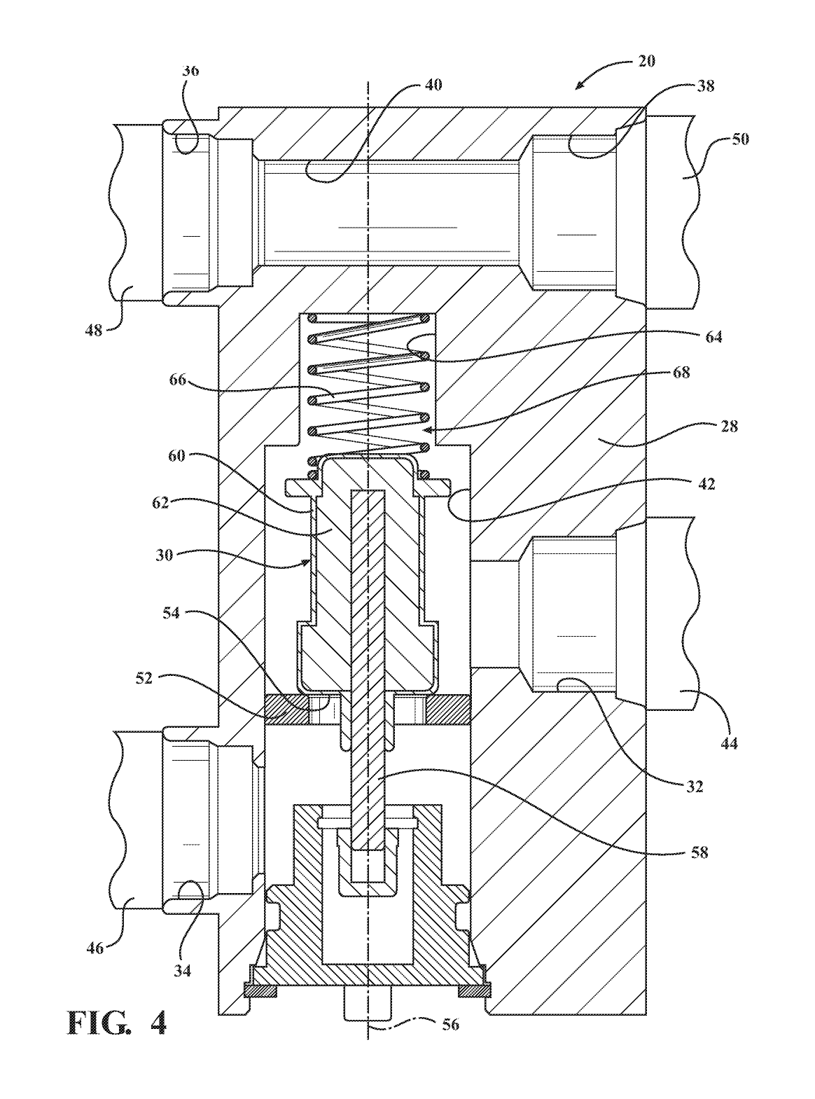

Referring to FIGS. 2 through 4, the valve member 30 is disposed in the valve chamber 42 of the housing 28. The valve member 30 is moveable between a first position, shown in FIG. 4, and a second position, shown in FIGS. 2 and 3. When disposed in the first position, the valve member 30 closes fluid communication between the first port 32 and the second port 34 to prevent the transmission fluid from circulating through the transmission fluid cooling circuit 22. When the valve member 30 is disposed in the second position, the valve member 30 connects the first port 32 and the second port 34 in fluid communication to allow the transmission fluid to circulate through the transmission fluid cooling circuit 22.

The housing 28 includes a first position land 52 defined by the valve chamber 42. The valve member 30 includes a seal surface 54 that seals against the first position land 52 when the valve member 30 is disposed in the first position to prevent fluid communication between the first port 32 and the second port 34. The seal surface 54 of the valve member 30 is axially spaced from the first position land 52 along a central axis 56 of the bypass valve assembly 20 when the valve member 30 is disposed in the second position.

The bypass valve assembly 20 includes rod 58 that extends along the central axis 56, and is generally concentric with the central axis 56. In the exemplary embodiment shown in the Figures and described herein, the rod 58 is fixed in position along the central axis 56 relative to the housing 28. However, in other embodiments that incorporate a pressure bypass system (not shown) into the bypass valve assembly 20, the rod 58 may be moveable along the central axis 56 relative to the housing 28. The valve member 30 includes an outer shell 60, which encapsulates a wax material 62. The rod 58 partially extends into an interior of the outer shell 60, and is partially surrounded by the wax material 62.

The housing 28 further defines a pocket 64, adjacent the valve chamber 42 along the central axis 56. A biasing device, such as but not limited to a coil spring 66, is disposed within the pocket 64, adjacent the valve member 30. The coil spring 66 biases against the valve member 30, axially along the central axis 56, to bias the valve member 30 toward and into sealing engagement with the first position land 52.

The bypass valve assembly 20 includes a temperature based actuating mechanism 68. The temperature based actuating mechanism 68 is operable to position the valve member 30 in the first position when the temperature of the transmission fluid is equal to or less than the pre-defined temperature. The temperature based actuating mechanism 68 is operable to position the valve member 30 in the second position when the temperature of the transmission fluid is equal to or greater than the pre-defined temperature.

In the exemplary embodiment shown and described herein, the temperature based actuating mechanism 68 includes the rod 58, the wax material 62 encapsulated within the valve member 30, and the coil spring 66. The temperature based actuating mechanism 68 operates based on the melting temperature of the wax material 62 of the valve member 30. The wax material 62 of the valve member 30 includes a melting temperature approximately equal to the pre-defined temperature, e.g., approximately 85° C. It should be appreciated that the melting temperature of the wax material 62 of the valve member 30 may differ from the exemplary temperature noted herein. It should also be appreciated that the temperature of the wax material 62 within the valve member 30, and thereby the temperature of the temperature based actuating mechanism 68 increases and/or decreases as the temperature of the transmission fluid increases and/or decreases respectively. When the temperature of the wax material 62 encapsulated within the valve member 30 increases to the melting temperature of the wax material 62, the wax material 62 begins to melt. As the wax material 62 melts, it expands, and biases against the portion of the rod 58 disposed within the valve member 30 and surrounded by the wax material 62, thereby moving the valve member 30 relative to the rod 58 and into the second position. As the wax material 62 cools and begins to solidify, the wax material 62 contracts, and the coil spring 66 biases the valve member 30 toward and into sealing engagement with the first position land 52, thereby moving the valve member 30 relative to the rod 58 into the first position. It should be appreciated that the temperature based actuating mechanism 68 may differ from the exemplary embodiment shown and described herein.

Referring to FIG. 2, the bypass valve assembly 20 further includes a temporary spacer 70. The temporary spacer 70 is a device built into the bypass valve assembly 20 to initially position the valve member 30 in the second position during assembly and initial filling of the transmission fluid cooling circuit 22, when the temperature of the transmission fluid and/or the temperature based actuating system is less than the pre-defined temperature, and would otherwise be positioned in the first position during normal operation described above. In the exemplary embodiment shown in the Figures and described herein, the temporary spacer 70 is disposed within the valve chamber 42, between the first port 32 and the second port 34. More specifically, in the exemplary embodiment shown in the Figures and described herein, the temporary spacer 70 is disposed between the first position land 52 and the seal surface 54 of the valve member 30. However, it should be appreciated that the temporary spacer 70 may be located at some other position within the bypass valve assembly 20 that is capable of positioning the valve member 30 in the second position. For example, one possible alternative position for the temporary spacer 70 may be located at the leftmost axial end of the rod 58, as viewed on the page of FIG. 2. Other embodiments may include the temporary spacer 70 located at other locations within the bypass valve assembly 20. The temporary spacer 70 positions the valve member 30 in the second position, even when the temperature of the temperature based actuating mechanism 68 is equal to or less than the pre-defined temperature.

The temporary spacer 70 has a melting temperature that is approximately equal to or greater than the pre-defined temperature. For example, the melting temperature of the temporary spacer 70 may be between 60° C. and 115° C. The specific value of the melting temperature of the temporary spacer 70 may vary from the exemplary range described above, and is dependent upon the pre-defined temperature at which the valve member 30 moves between the first position and the second position.

Preferably, the temporary spacer 70 includes and is manufactured from a wax compound. In some embodiments, the wax compound of the temporary spacer 70 and the wax material 62 encapsulated in the valve member 30 are the same material, having the same melting temperature. This ensures that the temporary spacer 70 and the wax material 62 encapsulated within the valve member 30 will melt at approximately the same temperature.

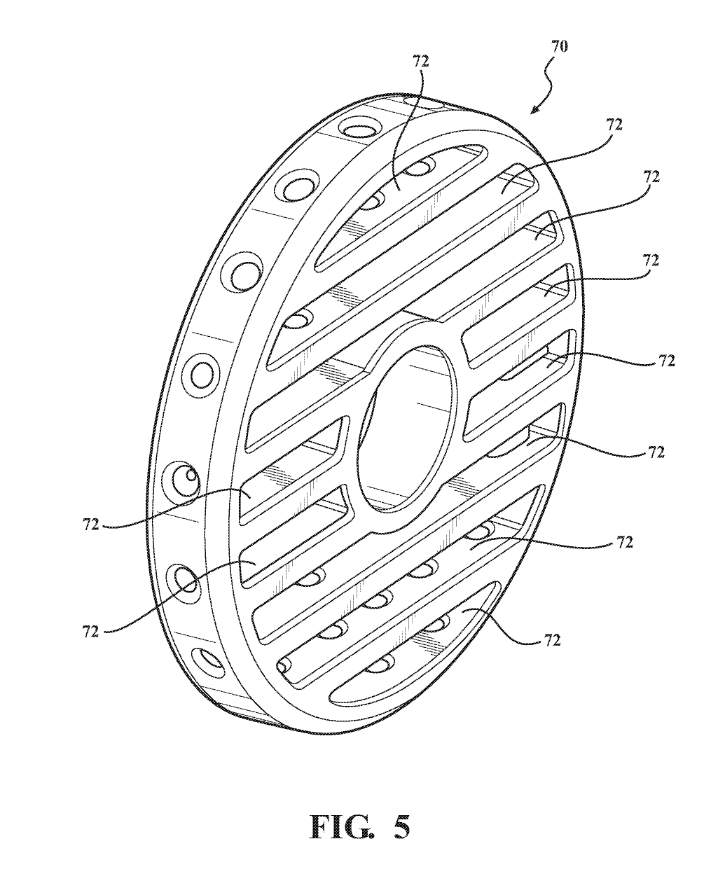

As noted above, the temporary spacer 70 of the exemplary embodiment is disposed between the seal surface 54 of the valve member 30 and the first position land 52. Referring to FIG. 5, the temporary spacer 70 includes at least one aperture 72 extending completely through the temporary spacer 70, axially along the central axis 56, thereby allowing fluid flow through the temporary spacer 70. The apertures 72 of the temporary spacer 70 allow the transmission fluid to flow from the first port 32, through and across the temporary spacer 70, and through the second port 34, thereby allowing the transmission fluid to circulate between the transmission 24 and the fluid cooler 26. It should be appreciated that the shape and/or configuration of the temporary spacer 70, including the number, size, and location of the apertures 72, and the location of the temporary spacer 70 within the bypass valve assembly 20 and relative to the valve member 30, may differ from the exemplary embodiment shown and described herein.

A method of assembling the transmission fluid circuit 22 described above is also provided. The method includes providing the bypass valve assembly 20. The bypass valve assembly 20, such as shown in FIG. 2 and including the temporary spacer 70, may be provided for initial assembly of the transmission fluid cooling circuit 22. The bypass valve assembly 20 is connected to the transmission 24 and the fluid cooler 26, to establish fluid communication between the bypass valve assembly 20 and the transmission 24, and between the bypass valve assembly 20 and the fluid cooler 26. Establishing fluid communication between the bypass valve assembly 20 and the transmission 24 includes connecting the transmission outlet line 44 in fluid communication with the transmission 24 and the first port 32 of the bypass valve assembly 20 for circulating the fluid from the transmission 24 to the bypass valve assembly 20, and connecting the transmission supply line 50 in fluid communication with the fourth port 38 of the bypass valve assembly 20 and the transmission 24 for circulating the fluid from the bypass valve assembly 20 to the transmission 24. Establishing fluid communication between the bypass valve assembly 20 and the fluid cooler 26 includes connecting the cooler supply line 46 in fluid communication with the second port 34 of the bypass valve assembly 20 and the fluid cooler 26 for circulating the fluid from the bypass valve assembly 20 to the fluid cooler 26, and connecting the cooler outlet line 48 in fluid communication with the fluid cooler 26 and the third port 36 for circulating the fluid from the fluid cooler 26 to the bypass valve assembly 20. It should be appreciated that once connected by the various fluid connection lines, the transmission 24, the bypass valve assembly 20, and the fluid cooler 26 cooperate to define the fluid circuit 22 through which the transmission fluid circulates in a loop.

Once the fluid cooler 26, the bypass valve assembly 20, and the transmission 24 have been connected to each other in fluid communication, the transmission fluid is circulated through the fluid circuit 22, with the transmission fluid being at a temperature less than the melting temperature of the temporary spacer 70, and less than or equal to the pre-defined temperature at which the valve member 30 moves between the first position and the second position. The temporary spacer 70, which is positioned in the bypass valve assembly 20 to position the valve member 30 in the second position, allows the transmission fluid to circulate or flow between the first port 32 and the second port 34, even though the temperature of the transmission fluid is less than the pre-defined temperature, and the bypass valve assembly 20 would be positioned in the first position to close fluid communication during normal operation. Accordingly, the temporary spacer 70 enables initial fluid flow between the first port 32 and the second port 34 during the initial filling and testing phase of the assembly. This enables the transmission fluid to be introduced into and circulate through the entire fluid circuit 22, even when the transmission fluid is at ambient temperatures and less than the pre-defined temperature at which the valve member 30 of the fluid bypass valve would normally open fluid communication to the entire fluid circuit 22. Because the transmission fluid is at a temperature that is less than the melting temperature of the temporary spacer 70, the temporary spacer 70 does not melt as the transmission fluid circulates through the fluid circuit 22.

Circulating the transmission fluid through the entire fluid circuit 22 during the initial assembly of the transmission fluid cooling circuit 22, allows the entire fluid circuit 22 to be inspected for leaks, without having to operate the vehicle and raise the temperature of the transmission fluid and/or the temperature based actuating mechanism 68 to a temperature equal to or greater than the pre-define temperature.

Once the fluid circuit 22 has been inspected for leaks and completely filled, the transmission fluid may be circulated through the fluid circuit 22 with the transmission fluid at a temperature equal to or greater than the melting temperature of the temporary spacer 70. At the first occurrence of the transmission fluid temperature increasing to a temperature that is equal to or greater than the melting temperature of the temporary spacer 70, the temporary spacer 70 will melt and dissolve into the transmission fluid, thereby allowing the bypass valve assembly 20 to operate as normal, with the valve member 30 able to move between the first position and the second position as the temperature of the transmission fluid changes, such as shown in FIGS. 3 and 4.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A fluid bypass valve assembly comprising:
a housing defining a first port, a second port, and a valve chamber;
a valve member disposed within the valve chamber and moveable between a first position closing fluid communication between the first port and the second port, and a second position connecting the first port and the second port in fluid communication;
wherein the valve member includes a temperature based actuating mechanism operable to position the valve member in the first position when a temperature of a fluid circulating through the housing is equal to or less than a pre-defined temperature, and wherein the temperature based actuating mechanism is operable to position the valve member in the second position when the temperature of the fluid is greater than the pre-defined temperature; and
a temporary spacer disposed within the valve chamber and positioning the valve member in the second position;
wherein the temporary spacer has a melting temperature approximately equal to the pre-defined temperature.

2. The fluid bypass valve set forth in claim 1 wherein the temporary spacer is a wax compound.

3. The fluid bypass valve set forth in claim 1 wherein the temporary spacer includes at least one aperture allowing fluid flow through the temporary spacer.

4. The fluid bypass valve set forth in claim 3 wherein the housing includes a first position land against which the valve member seals when the valve member is disposed in the first position, and wherein the temporary spacer is disposed between the valve member and the first position land.

5. The fluid bypass valve set forth in claim 1 wherein the melting temperature of the temporary spacer is between 60° C. and 115° C.

6. The fluid bypass valve set forth in claim 1 wherein the temperature based actuating mechanism includes at least one coil spring.

7. The fluid bypass valve set forth in claim 6 wherein the valve member includes an outer shell encapsulating a wax material, and wherein the wax compound of the temporary spacer and the wax material of the valve member are the same material.

8. A transmission fluid circuit comprising:
a transmission;
a fluid cooler;
a bypass valve assembly including a housing defining a first port, a second port, a third port, a fourth port, a first passage connecting the third port and the fourth port in fluid communication, a valve chamber;
a transmission outlet line attached to and disposed in fluid communication with the transmission and the first port for circulating fluid from the transmission to the bypass valve assembly;
a cooler supply line attached to and disposed in fluid communication with the second port and the fluid cooler for circulating fluid from the bypass valve assembly to the fluid cooler;
a cooler outlet line attached to and disposed in fluid communication with the fluid cooler and the third port for circulating fluid from the fluid cooler to the bypass valve assembly;
a transmission supply line attached to and disposed in fluid communication with the fourth port and the transmission for circulating fluid from the bypass valve assembly to the transmission;
a valve member disposed in the valve chamber and moveable between a first position closing fluid communication between the first port and the second port, and a second position connecting the first port and the second port in fluid communication;
wherein the valve member includes a temperature based actuating mechanism operable to position the valve member in the first position when a temperature of the temperature based actuating mechanism is equal to or less than a pre-defined temperature, and wherein the temperature based actuating mechanism is operable to position the valve member in the second position when the temperature of the temperature based actuating mechanism is greater than the pre-defined temperature; and
a temporary spacer disposed within the valve chamber, between the first port and the second port, and positioning the valve member in the second position when the temperature of the temperature based actuating mechanism is equal to or less than the pre-defined temperature;
wherein the temporary spacer has a melting temperature equal to or greater than the pre-defined temperature.

9. The transmission fluid circuit set forth in claim 8 wherein the temporary spacer is a wax compound.

10. The transmission fluid circuit set forth in claim 8 wherein the temporary spacer includes at least one aperture allowing fluid flow through the temporary spacer.

11. The transmission fluid circuit set forth in claim 10 wherein the housing includes a first position land against which the valve member seals when the valve member is disposed in the first position, and wherein the temporary spacer is disposed between the valve member and the first position land.

12. The transmission fluid circuit set forth in claim 8 wherein the melting temperature of the temporary spacer is between 60° C. and 115° C.

13. The transmission fluid circuit set forth in claim 8 wherein the valve member includes an outer shell encapsulating a wax material, and wherein the wax compound of the temporary spacer and the wax material of the valve member are the same material.

14. A method of assembling a transmission fluid circuit of a vehicle, the method comprising:
providing a bypass valve assembly including:
a housing defining a first port, a second port, and a valve chamber;
a valve member disposed within the valve chamber and moveable between a first position closing fluid communication between the first port and the second port, and a second position connecting the first port and the second port in fluid communication;
wherein the valve member includes a temperature based actuating mechanism operable to position the valve member in the first position when a temperature of the temperature based actuating mechanism is equal to or less than a pre-defined temperature, and wherein the temperature based actuating mechanism is operable to position the valve member in the second position when the temperature of the temperature based actuating mechanism is greater than the pre-defined temperature; and
a temporary spacer disposed within the valve chamber, between the first port and the second port, and positioning the valve member in the second position when the temperature of the temperature based actuating mechanism is equal to or less than the pre-defined temperature;
wherein the temporary spacer includes a melting temperature approximately equal to the pre-defined temperature
establishing fluid communication between the bypass valve assembly and a transmission, and between the bypass valve assembly and a fluid cooler, wherein the transmission, the bypass valve assembly, and the fluid cooler cooperate to define a fluid circuit through which a fluid circulates in a loop;
circulating the fluid through the fluid circuit with the fluid at a temperature of less than the melting temperature of the temporary spacer;
inspecting the fluid circuit for leaks; and
circulating the fluid through the fluid circuit with the fluid at a temperature equal to or greater than the melting temperature of the temporary spacer to melt the temporary spacer and dissolve the temporary spacer into the fluid.

15. The method set forth in claim 14 wherein the housing of the bypass valve assembly further includes a third port, a fourth port, and a first passage connecting the third port and the fourth port in fluid communication, and wherein establishing fluid communication between the bypass valve assembly and the transmission includes connecting a transmission outlet line in fluid communication with the transmission and the first port for circulating the fluid from the transmission to the bypass valve assembly, and connecting a transmission supply line in fluid communication with the fourth port and the transmission for circulating the fluid from the bypass valve assembly to the transmission.

16. The method set forth in claim 15 wherein establishing fluid communication between the bypass valve assembly and a fluid cooler includes connecting a cooler supply line in fluid communication with the second port and the fluid cooler for circulating the fluid from the bypass valve assembly to the fluid cooler, and connecting a cooler outlet line in fluid communication with the fluid cooler and the third port for circulating the fluid from the fluid cooler to the bypass valve assembly.

17. The method set forth in claim 14 wherein the temporary spacer is a wax compound.

18. The method set forth in claim 14 wherein the temporary spacer includes at least one aperture allowing fluid flow through the temporary spacer.

19. The method set forth in claim 14 wherein the housing includes a first position land against which the valve member seals when the valve member is disposed in the first position, and wherein the temporary spacer is disposed between the valve member and the first position land.

20. The method set forth in claim 14 wherein the melting temperature of the temporary spacer is between 60° C. and 115° C.
